(19) United States
(12) Patent Application Publication
(10) Pub. No.: US 2010/0322496 A1
(43) Pub. Date: Dec. 23, 2010

(54) METHOD AND SYSTEM FOR ANATOMY STRUCTURE SEGMENTATION AND MODELING IN AN IMAGE

(75) Inventors: Jimin Liu, Helios (SG); Su Huang, Helios (SG); Wieslaw Lucjan Nowinski, Helios (SG)

Correspondence Address: Patent Docket Department;Armstrong Teasdale LLP, 7700 Forsyth Boulevard, Suite 1800, St. Louis, MO, 63105, US

(73) Assignee: Agency for Science, Technology and Research, Singapore (SG)

(21) Appl. No.: 12/735,962

(22) PCT Filed: Feb. 27, 2009
(86) PCT No.: PCT/SG2009/000075

§ 371 Date: Aug. 27, 2010

Related U.S. Application Data
(60) Provisional application No. 61/032,518, filed on Feb. 29, 2008.

(51) Int. Cl. G06K 9/00

(52) U.S. Cl. 382/131

(57) ABSTRACT

A method is proposed for segmenting one or more ventricles in a three-dimensional brain scan image (e.g. MR or CT). The image is registered against a brain model, which ventricle models of each of the one or more ventricles. Respective regions of interest are defined based on the ventricle models. Object regions are first obtained by applying region growing procedure in the regions of interest, and then trimmed based on anatomical knowledge. A 3D surface model of one or more objects is constructed within a 3D space from the segmented structure. A 3D surface is edited and refined by a user selecting amendment points in the 3D space which are indicative of missing detail features. A region of the 3D surface near the selected points is then warped towards the amendment points smoothly, and the modified patch is combined with the rest of the 3D surface yields the accurate anatomy structure model.

### REFERENCE TO RELATED APPLICATIONS

This application is a 371 National Stage application based on PCT/SG2009/000075, filed Feb. 27, 2009, which is based on U.S. provisional application 61/032,518, filed Feb. 29, 2008.

### FIELD OF THE INVENTION

The present invention relates to a method and system for segmenting anatomy structures in an image, a method and system for constructing a 3D surface model of a segmented structure. The particular application example is the segmentation and modeling of brain ventricular system in medical images, such as MR images and CT images.

### BACKGROUND OF THE INVENTION

As shown in FIG. 1, the human cerebral ventricular system consists of four intercommunicating chambers, namely the left lateral ventricle, right lateral ventricle, third ventricle and fourth ventricle. The ventricles are filled with cerebrospinal fluid (CSF), surrounded by white matter (WM) and gray matter (GM). The two lateral ventricles, located within the cerebrum, are relatively large and C-shaped, roughly wrapping around the dorsal aspects of the basal ganglia. Each lateral ventricle extends into the frontal, temporal and occipital lobes via the anterior, inferior and posterior horns respectively. The lateral ventricles both communicate via the interventricular foramina with the third ventricle (found centrally within the diencephalon) whereas the third ventricle communicates via the cerebral aqueduct (located within the midbrain) with the fourth ventricle (found within the hindbrain). Abbreviations in the figure are defined as: AC: Anterior Commissure; BC: Basal Cistern (Interpeduncular Cistern); CC: Corpus Callosum; CP: Cerebral Peduncle; CQ: Corpora Quadrigemina HP: Hypophysis (Putuitary Gland); ICV: Internal Cerebral Vein (in transverse fissure); IS: Infundibular Stalk; LT: Lamina Terminalis; LV: Lateral Ventricles; MI: Massa Intermedia (Middle Commissure); MO: Medulla Oblongata; OC: Optic Chiasma; PC: Posterior Commissure; PG: Pineal Gland; SP Septum Lucidum; TC: Tuber Cinereum; TF: Transverse Fissure (Subarachnoid Space Under Corpus Callosum); V3: The Third Ventricle; V4: The Forth Ventricle.

MR imaging has made it possible to obtain in vivo 3D images of the human brain noninvasively. Since changes in the CSF volume and ventricle shapes are commonly associated with several intrinsic and extrinsic pathologies, segmentation and quantification of the ventricular system from MR images are therefore of primary importance.

Since manual segmentation of ventricles is time consuming, subjective and non-reproductive (or non-repeatable), a number of automated methods have also been proposed for the segmentation of ventricles. In general, methods for segmentation of ventricles can be classified into either model-based methods or non model-based methods depending on whether 3D ventricular models are used.

Non model-based methods, such as intensity thresholding [17] and region growing [12, 13, 19] are adaptive to the shape and size variations of the ventricular system. However, since these methods do not utilize the shape prior-knowledge of the ventricles, “leakage” from the ventricular regions to the non-ventricular regions may arise. Furthermore, some ventricular regions may be left out by these methods due to the non-homogeneity of the images or the presence of noise and partial volume artifacts in the images. The accurate segmentation of the third ventricle is especially challenging when using these non model-based methods since the precise boundaries of the third ventricle depend on the shape and topological constraints of themselves and their relationship with surrounding objects.

On the contrary, model-based methods, such as atlas warping [4] or geometrical and parametric model deformation [3, 6, 18], adopt an explicit or implicit model to act as the shape prior knowledge of the ventricles. These methods are robust to noise and are able to achieve precise segmentation when the variation between the shapes of the model and the studied object is small. However, due to the large variation in the shapes and sizes of the ventricles, it is difficult to design a reasonable energy or similarity function to achieve a model deformation adaptable to every variation. Furthermore, the local minimization problem which causes the false segmentation inevitably exists in these methods.

In general, there are two main difficulties in the segmentation of anatomic structures from images. First, transition regions between a studied structure (for example, the ventricular system) and its surrounding tissues (for example, gray matters) may be present due to the partial volume effect. If these transition regions are completely excluded, the structure may be under-segmented or broken into several disconnected components. Second, some boundaries between the studied structure and its surrounding tissue are too thin to be detected in the image. As a result, some object regions may “leak” (i.e. connect) to other non-object regions. Currently, no existing method can detect the transition regions and at the same time, prevent the “leaking” of object regions to non-object regions.

### SUMMARY OF THE INVENTION

The present invention aims to provide a method and system for the segmentation and constructing 3D surface models of structures in an image.

Specifically, the present invention proposes a method for segmenting one or more ventricles in a three-dimensional brain scan image composed of brain scan data. The method comprises of the steps:
(a) registering a brain model, which comprises one or more respective ventricle models of each of the one or more ventricles, with the image, thereby forming a correspondence between locations in the brain model and respective locations in the brain scan image;
(b) according to said correspondence, defining one or more respective regions of interest in the image based on the one or more ventricle models;
(c) performing region growing on the one or more regions of interest using the brain scan data to form respective volumes indicative of the respective ventricles; and
(d) segmenting the brain scan image using the respective volumes.

The invention may further include a step of constructing a surface model of the segmented anatomy structure and editing the surface model to accurately describe the features and details lost in segmentation.

Step (c) may include generating the volumes in the form of connected regions, and prior to step (d) there may be steps of trimming the volumes based on anatomical knowledge specific to the ventricle concerned.

The invention may alternatively be expressed as a computer system for performing such methods. This computer system may be integrated with devices for acquiring the image. The invention may also be expressed as a computer program product, such as one recorded on a tangible computer medium, containing program instructions operable by a computer system to perform the steps of the methods.

### BRIEF DESCRIPTION OF THE FIGURES

This patent or patent application publication contains at least one drawing executed in color. Copies of this patent or patent application publication with color drawing(s) will be provided by the Office upon request and payment of the necessary fee. This patent or patent application publication contains at least one drawing executed in color. Copies of this patent or patent application publication with color drawing(s) will be provided by the Office upon request and payment of the necessary fee.

An embodiment of the invention will now be illustrated for the sake of example only with reference to the following drawings, in which:

FIG. 1(a)-(c) illustrate one example of the human cerebral ventricular system.

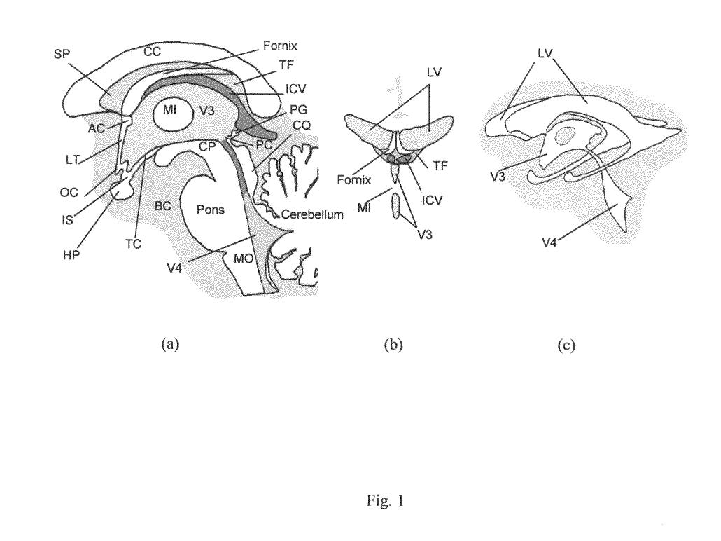

FIG. 2 illustrates the main flow chart of a system which is an embodiment of the invention comprising method steps 202 and 204;

FIG. 3 illustrates the flow chart of the method 202 for segmenting a ventricular system from an image;

FIG. 4 illustrates a flow chart of a method 204 for generating an accurate 3D surface model of a ventricular structure from its segmentation output of method 202;

FIG. 5 illustrate a process of modifying a surface model using an amendment point according to an embodiment of the present invention;

FIG. 6 illustrates the results obtained by segmenting a left ventricle in data set IBSR-18 using method 202;

FIG. 7 illustrates the results obtained by segmenting a third ventricle in data set IBSR-18 using method 202;

FIG. 8 illustrates the results obtained by segmenting a fourth ventricle in data set IBSR-18 using method 202;

FIG. 9 illustrates four ventricular structures segmented from four different brain volume sets in data set BIL-20 using method 202.

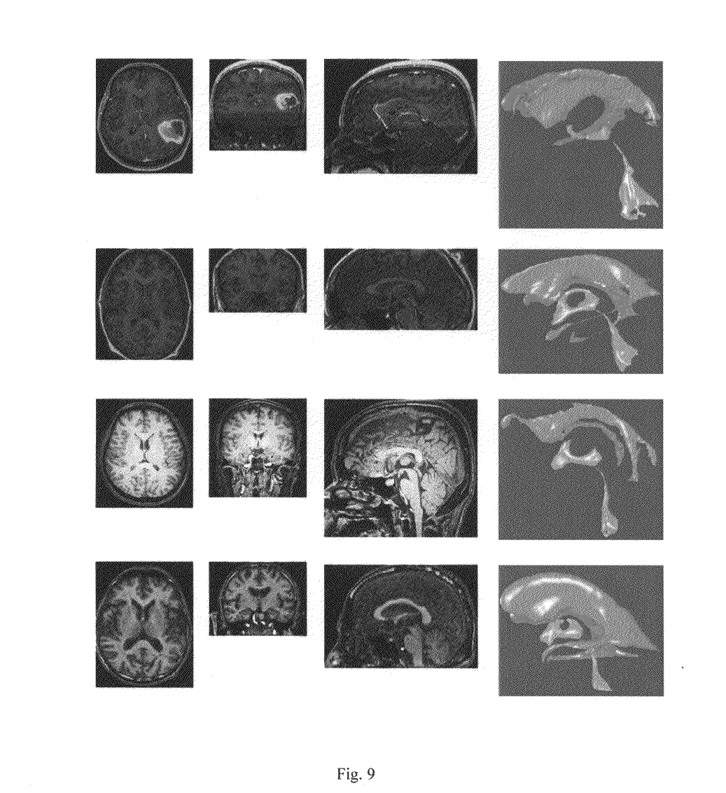

### DETAILED DESCRIPTION OF THE EMBODIMENTS

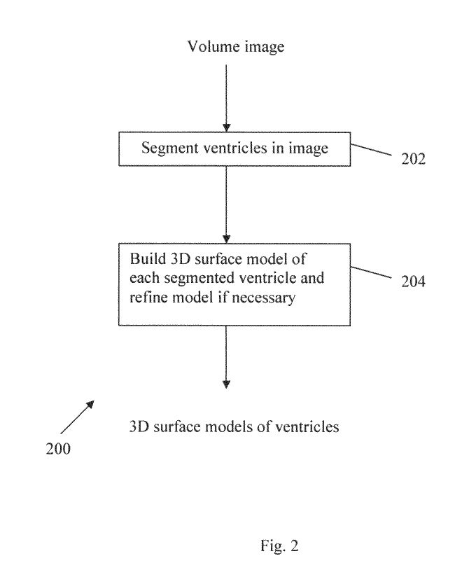

Referring to FIG. 2, the steps are illustrated of a method 200 which is an embodiment of the present invention and which generates 3D surface models of ventricles.

The input to method 200 is a volume image. In step 202, the ventricles in the volume image are segmented. In step 204, a 3D surface model is built for each ventricle and the 3D surface model is edited to improve its accuracy. Note that in other embodiments step 202 may not be followed by step 204. Furthermore, the methods of steps 204 have other possible applications than in the method 200, and may be performed separately, or in combination, in a wide range of 3-D modelling situations.

### Step 202: Segment Ventricles in Volume Image

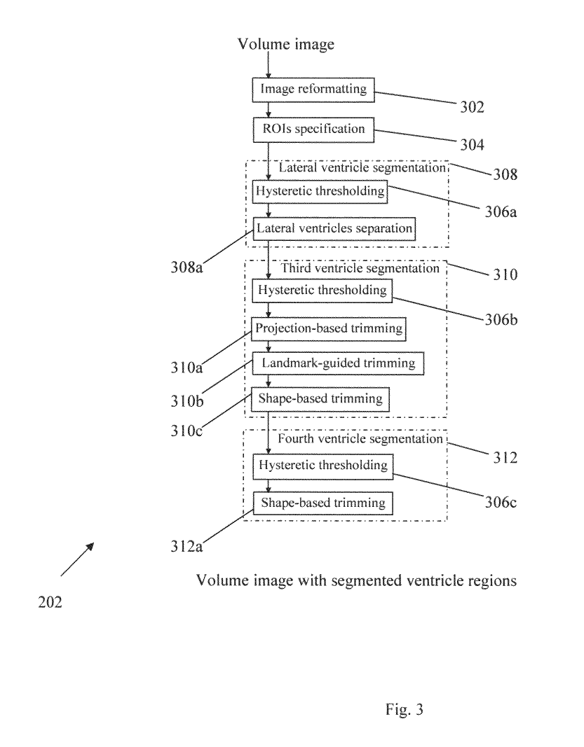

Referring to FIG. 3, the steps are illustrated of a method 202 which is an embodiment of the present invention and which generates a volume image indicating a ventricular system.

The input to method 202 is a volume image. In step 302, the image is reformatted to the standard Talairach space and the standard ventricular model is then warped onto the image according to a plurality (e.g. 10) of automatically identified ventricular landmarks. In step 304, the region of interest for each ventricle is specified using the deformed ventricular model. In steps 308, 310 and 312, the lateral, third and fourth ventricles are segmented. Hysteric thresholding (that is, thresholding with a hysteresis) is performed in steps 306a, 306b and 306c to generate a connected CSF region containing a ventricular component, with the CSF region containing minimal non-ventricular regions.

### Step 302: Reformat Image

Given a volume image I, Talairach transformation [9] is commonly used to reformat the image I into the standard Talairach space [14] so that it can be processed or understood with anatomical knowledge. However, occasionally when the Talairach landmarks cannot be located automatically, the Talairach transformation cannot be automated.

Therefore, in example embodiments, a cortical outline-based registration approach is used to reformat the image. A cortical outline of a brain is an approximation convex hull of its cortical surface. The cortical outline S₁ in the image is automatically extracted using morphologic analysis [11] and the cortical outline S₂ in the 3D Talairach space is generated by interpolating [8] the 2D digital electronic version of the 3D Talairach-Tournoux (TT) brain atlas and the ventricular system in the 3D TT brain atlas [8] is taken as the standard volumetric ventricular model.

The outlines S₁ and S₂ are represented by triangular meshes, with vertices denoted as Q₁ and Q₂ respectively. Applying the Iterated Closest Points (ICP) method [2] to register the point set Q₁ to Q₂, a linear transformation is obtained and is used to reformat the image I into the Talairach space. The standard radiological convention (http://www.grahamwideman.com/gw/brain/orientation/orientterms.htm) is adopted to define a coordinate system (xyz) in the Talairach space with its origin located at the anterior commissure of the 3D TT atlas, with x running from the subject's right to left, y running from the subject's posterior to anterior and z running from the subject's inferior to superior.

### Step 304: Specify Region of Interest

In example embodiments, to specify the region of interest for each ventricular component, ten ventricular landmarks [7] are first identified in the image and in the 3D TT atlas. A model-based semi-global approach is used to automatically identify the ten ventricular landmarks in the image whereas the tool Medical Image Understanding Environment (MIUE) [7, 8] is used to interactively specify these landmarks in the 3D TT atlas as domain knowledge.

In one example, four of these landmarks are on each lateral ventricle and they are the most posterior point, the most superior point, the anterior lateral frontal pole and the posterior center-line intersection of each lateral ventricle. The landmarks also include the anterior pole on the third ventricle and the posterior-superior point on the fourth ventricle.

Based on the ten ventricular landmarks in the image and the TT brain atlas, the standard ventricular model is then registered onto the image. Since the localization of the automatically detected landmarks may not be accurate [7, 10], a thin plate spline approximation approach [10] is used to obtain the registration (or warping) function.

The warped (or deformed) volumetric ventricular model is then divided into four sub-volumes: V, (left lateral ventricle), V₂ (right lateral ventricle), V₃ (third ventricle) and V₄ (fourth ventricle and adequate). The corresponding regions of interest Ωᵢ for each ventricular component are then defined by expanding the corresponding warped sub-volume Vᵢ according to Equation (1).

$${Ω}_{i} = \{ \begin{matrix}\{ p \vert s ( {V}_{i} , p ) \leq {d}_{0} \} - {V}_{0} & ( i = 1 , 2 ) \\ \{ p \vert s ( {V}_{i} , p ) \leq {d}_{0} \} & ( i = 3 , 4 )\end{matrix} \qquad ( 1 )$$

In Equation (1), the regions of interest Ω₁ to Ω₄ are used for the segmentation of the left lateral, right lateral, third and fourth ventricles respectively. s(Vᵢ,p) indicates the signed minimal Euclidean distance of the voxel p (p=(pₓ, p_{y}, p_{z})εR³) to the boundary of the volume V₁, with a positive value of s(Vᵢ, p) indicating that the voxel p is outside the volume Vᵢ and a negative value of s(Vᵢ,p) indicating that the voxel p is inside the volume Vᵢ. In one example, d₀ is set to 6 mm so that each region is just large enough to contain three type of brain tissue: gray matter, white matter and CSF including the related ventricular component. This allows the threshold for the related ventricular component to be subsequently estimated in the region. In addition, V₀ represents the middle sagittal slab. In one example, the thickness of V₀ is set to 8 mm according to Equation (2) and V₀ is excluded from Ω₁ and Ω₂ to prevent the “leakage” of the two lateral ventricles into the inter-hemisphere CSF or the “leakage” of the two lateral ventricles into each other.

V₀={p|−4≦x≦4} (2)

Steps 306a, 306b and 306c: Perform Hysteretic Thresholding

Although several methods [5, 15, 16, 21] are available to segment CSF regions from brain volumes, the extracted CSF regions usually contain not only the ventricular regions but also a large part of the non-ventricular regions. It is difficult to segment the ventricular regions from the numerous inter-connected non-ventricle regions. As a result, these methods may fail to locate the transition regions between the ventricular CSF and the non-ventricular tissues, resulting in under-segmentation. Although existing methods [20] are available for extracting transition regions, these methods are either gradient-based or local entropy-based. Therefore, they are likely to extract a large part of non-ventricular CSF regions as transition regions.

In example embodiments, the regions of interest Ω₁ (Ω₁ to Ω₄) specified in step 304 are used as a guide in steps 306a, 306b and 306c to collect a connected CSF region X that contains its corresponding ventricle component. In steps 306a, 306b and 306c, hysteretic thresholding is used to collect the region X corresponding to region Ωᵢ according to the following sub-steps:

Step 1: Two pairs of intensity thresholds for the ventricular component in each region Ωᵢ is calculated respectively.

In one example, step 1 is performed according to the following steps.

Firstly, the fuzzy c-mean method [1] is used to classify all voxels of the image in the region Ωᵢ into five clusters according to their intensities. These five clusters represent three types of tissue (GM, WM and CSF) and two transition regions CSF_GM (between CSF and GM) and GM_VM (between GM and WM)).

Next, denoting the membership of intensity g to cluster k as uₖ(g) and the intensity of each cluster center as cₖ (k=1, 2, . . . , 5) and without loss of generality, supposing that c₁<c₂< . . . c₅, the intersection point gₖ of two membership functions uₖ and uₖ₊, is then calculated such that uₖ(gₖ)=uₖ₊₁(gₖ) where k=1, 2, . . . , 4. The low and high thresholds t_{kL} and t_{kH} of cluster k are then set to gₖ₋₁ and gₖ respectively, with gₒ and g₅ being set to the possible minimum and maximum intensities respectively.

According to domain knowledge, two clusters corresponding to the CSF and CSF_GM are then picked out. In one example, in the T1-MR images, the first cluster with intensity thresholds [t_{1L}, t_{1H}] is selected as CSF_GM. The threshold containing the CSF cluster is taken to be the narrow threshold [T_{L1}, T_{H1}] whereas the threshold containing both the CSF and the CSF_GM clusters is taken to be the wide threshold [T_{L2}, T_{H2}]. In other words, T_{L1}=t_{1L}, T_{H1}=t_{1H}, T_{L2}=min{t_{1L}, t_{2L}}, T_{H2}=max{t_{1H}, t_{2H}}.

Step 2: For each Ωᵢ a corresponding kernel region K of the ventricular component is collected according to the narrow thresholds [T_{L1}, T_{H1}];

In one example, step 2 is performed according to the following steps.

Firstly, the image I is binarized with the low and high thresholds T_{L1} and T_{H1} to obtain the CSF cluster {p|T_{L1}≦I(p)≦T_{H1}}. Next, the maximum connected region K is extracted from the CSF cluster according to the 6-neighbor connectivity. Since the region Ωᵢ is generated by expanding the deformed ventricular component, which is a rough fit of the corresponding ventricular component in the image, naturally, the region K is or at least includes the main part of the related lateral ventricle in the region Ω. In other words, the region K obtained from the region Ω₃ includes the main part of the third ventricle, while the region K obtained from each of the other regions, is the main part of the left lateral ventricle, right lateral ventricle, or the fourth ventricle. The region K is denoted as a kernel region of the related ventricle component.

Step 3: The region K is adaptively expanded to include transition regions according to the wide thresholds [T_{L2}, T_{H2}].

In one example, step 3 is performed using a boundary patch-based region growing procedure to adaptively expand the region K to include the transition regions of the ventricular component and at the same time to avoid “leaking” of the region K to non-ventricular regions.

A boundary voxel p of the volume is taken to be an active voxel if at least one of its 26 nearest-neighbors q is such that qεΩ-K and T_{L2}≦I(q)≦T_{H2}. Active boundary voxels of K are then grouped into a set of boundary patches {∂₁, ∂₂, . . . , ∂ₙ} according to the 26-neighbor connectivity, where n represents the number of patches. All voxels within a patch ∂ᵢ are 26-neighbor connected, while two different patches ∂ᵢ and ∂ⱼ (i≠j) are disconnected.

Region growing is applied on each patch ∂ᵢ separately. Initially, ∂_{i,0} is set as ∂ᵢ and ∂_{i,k+1} is repeatedly generated from ∂_{i,k} according to Equation (3). In Equation (3), N₂₆(p) represents the 26-neighbor of the voxel p.

$${\partial }_{i , k + 1} = {⋃}_{p ∈ {\partial }_{i , k}} \{ q \vert q ∈ {N}_{26} ( p ) , {T}_{L 2} \leq I ( q ) \leq {T}_{H 2} , q ∈ Ω \} - ( K {⋃}_{j = 0}^{k} {\partial }_{k , j} ) ( k = 0 , 1 , 2 , … ) \qquad ( 3 )$$

The procedure of generating from ∂_{i,k+1} continues until at k=kᵢ is empty or until the number of voxels in ∂_{i,k}_{ᵢ}₊₁ is more than twice the number of voxels in ∂_{i,k}_{ᵢ} i.e. #∂_{i,k}_{ᵢ}₊₁>∂_{i,k}_{ᵢ}*2. The stopping condition of #∂_{i,k}_{ᵢ}₊₁<#∂_{i,k}_{ᵢ}*2 is to avoid “leaking” of the transition regions to the non-ventricular regions since the size of the transition regions is expected to be of the same scale as that of ∂_{i,0}.

At the end of the procedure, a new volume Vᵢ=Uₙ₌₀^{k}_{ᵢ}∂_{i,n} is obtained from the patch ∂_{i,0}. Finally, the newly expanded volume Vᵢ and the kernel region K are combined to generate a connected CSF region X according to Equation (4).

X=∪ᵢ₌₀ⁿ(∪ₙ₌₀ₖ_{ᵢ}∂_{i,n})∪K (4)

In steps 306a, 306b and 306c of steps 308, 310 and 312 respectively, the connected CSF region is further trimmed according to the domain knowledge about the shape, intensity and anatomy of the ventricular system as follows.

### Step 308: Lateral Ventricle Segmentation

To segment the two lateral ventricles, hysteretic thresholding is applied on the regions Ω₁ and Ω₂ separately to obtain two volumes X₁ and X₂ which are the main parts of left and right ventricles. To detect the possible remaining parts of the lateral ventricles in the middle sagittal slab V₀, the boundary patches ∂₁ and ∂₂ of X₁ and X₂ that are inside the region V₀, respectively, are first located and the boundary patch-based region growing procedure is then used to adaptively expand ∂₁ and ∂₂ in the region V₀. Two new volumes X₁ and X₂, which contain the remaining parts of the left and right lateral ventricles, are hence obtained.

Step 308a: Lateral Ventricle Separation

When the septum pellucidum between the two lateral ventricles is large enough (in one example, at least one voxel thickness in the sagittal direction. This occurs in about 30% of subjects in the test data sets), X₁ and X₂ are separate (i.e., the overlap X₁₂=X₁∩X₂ of the volumes X₁ and X₂ is empty), and X₁∪X₁ and X₂∪X₂ are taken to be the left and right ventricles respectively. In the case when the septum pellucidum is very thin, the two regions X₁ and X₂ may be joined together by the non-empty overlap region X₁₂, it is then necessary to separate the left and right lateral ventricles according to the following steps: first, X₁₂ is removed from X₁ and X_{Z} to obtain two regions X′₁=X₁−X₁₂ and X′₂=X₂−X₁₂. Then, for each voxel p in X₁₂, if its distance to the boundary of region X′₁ is less than that to region X′₂, i.e., s(X′₁, p)<s(X₂, p), the voxel p is distributed into X′₁, otherwise if s(X′₁, p)>s(X₂, p), the voxel p is distributed into X′₂. If s(X′₂, p)=s(X′₂, p), p is regarded as a voxel from the septum lucidum. Finally, the unions) X₁∪X, and X₂∪X′₂ are taken as the segmentation of the left and right ventricles, i.e., X₁ and X₂ are updated to) X₁∪X′₁ and X₂∪X′₂, respectively.

### Step 310: Third Ventricle Segmentation

Hysteretic thresholding is first applied to region Ω₃ to obtain a connected CSF volume X₃.

Next, voxels identified to be a part of either the left or right lateral ventricle are removed from X₃. In other words, X₃ is updated to be X₃−(X₁+X₂). Finally, other extra-ventricular voxels are removed from X₃.

Step 310a: Projection-Based Non-Ventricular Region Trimming

In one example, a projection-based trimming method is used to remove non-ventricular voxels from X₃. Since the third ventricle is a narrow opening in the middle of the brain and the non-ventricular part contained in the volume X₃ is much wider than the third ventricle along the sagittal (left-to-right) direction. The steps of the project-based trimming method are as follows.

Step 1: A two-dimensional image f(y,z) is generated by projecting the volume X₃ onto the middle sagittal plane x=0 according to Equation (6).

f(y,z)=#{p|p_{y}=y,p_{z}=z,pεX₃} (6)

In Equation (6), # represents the cardinal of a set i.e. at a point (y, z) in the plane x=0, f(y,z) represents the number of voxels of volume X₃ on the project line at the point (y, z).

Step 2: A fuzzy c-mean method is then used to classify all non-zero values {f(y,z)≠0} into two clusters and an adaptive threshold h is obtained whereby f(y,z) is less than h in one cluster and is more than h in the other cluster.

Step 3: For each voxel pεX₃, if f(p_{y}, p_{z})>h, the voxel is removed from X₃.

Step 310b: Landmark Guided Non-Ventricular Region Trimming

After applying the projection-based extra-ventricle trimming method, X₃ may still contain a small narrow non-ventricular region at the anterior-inferior part of the third ventricle. In one example, a landmark guided non-ventricular region trimming method is used to remove this non-ventricular region. In the landmark guided non-ventricular region trimming method, all voxels anterior to the anterior pole of the third ventricle are removed. The landmark (anterior pole of the third ventricle) is identified in the image using the model-based approach [7].

Step 310c: Shape-Based Non-Ventricular Region Trimming

At the superior of the third ventricle, X₃ may contain a thin C-shaped region composed of the Transverse Fissure and the ICV. Furthermore, from the PC (or PG) towards the inferior-posterior, X₃ may contain one or more small narrow paths “leaking” to the basal cistern. In one example, these “leakages” are removed using a shape-based non-ventricular region trimming method based on the strip-like shape features of the “leakages”. Firstly, all candidate components for removal are located by grouping connected regions on coronal slices from posterior to anterior. Next, from these candidate components, strip-like “leakages” are identified and removed. In one example, the following sub-steps are performed in the shape-based non-ventricular region trimming method.

Step 1: A candidate leakage component set [symbol] and a temporary component set [symbol] ₀ are initialized.

In step 1, the most posterior coronal slice y₀=min{y|p(x,y,z) E X₃} of the volume X₃ is located, and [symbol] is set to empty whereas [symbol] is set to {{C₀}|C₀εS₀}, where C₀ denotes one of all the 8-neighbor connected regions S₀ of X₃ on the coronal slice indexed by y₀, {C₀} is a candidate leakage component composed of region C₀.

Step 2: All candidate leakage components are located by tracing each component in [symbol] to generate [symbol] ₖ₊₁(k=0, 1, 2 . . . ).

For each component Lₖ={C₀, C₁, . . . , Cₖ}ε [symbol] , if there is a 8-neighbor connected region Cₖ₊₁ on the coronal slice indexed by y₀+k+1, and Cₖ₊₁ is connected to Cₖ in the sense that there is at least one voxel pₖ₊₁εCₖ₊₁ that is a 26-neighbor of another voxel pₖεCₖ, the region Cₖ₊₁ is appended to the component Lₖ to form a new component Lₖ+₁={Cₒ, C₁, . . . , Cₖ, Cₖ₊₁}.

If the area ratio of the voxels in Cₖ₊₁ to the voxels in Cₖ is greater than a given threshold r (in one example, r is set as 3), Lₖ₊₁ is appended into [symbol] . Otherwise Lₖ₊₁ is appended into [symbol] for further growing. If [symbol] ₖ₊₁ is not empty, step 2 is repeated by generating [symbol] from [symbol] .

Step 3: In step 3, the C-shape leakage component on the superior of X₃ is removed.

A candidate component Lₖ₊₁={C₀, C₁, Cₖ, Cₖ₊₁}ε [symbol] is identified as the C-shape leakage component composed of transverse fissure and the ICV if it satisfies the following three conditions.

(1) Cₖ₊₁ is a branch region, i.e., there is another connected region C′ₖεS(k) and C′ₖ≠Cₖ.
(2) The angle ∠PₖPₖ₊₁P′ₖ is less than 30°, where Pₖ, Pₖ₊₁, are the mass centers of region Cₖ, Cₖ₊₁ and C′ₖ, respectively, and,
(3) each region C₁εLₖ₊₁ (i=0, 1, . . . k+1) is on the superior of all voxels of X₃ in the coronal slice indexed by y₀+i, i.e., max{z|p(x,y₀+i,z)εCᵢ}>max{z|p(x,y₀+i,z)εX₃−Cᵢ}

If Lₖ₊₁={C₀, C₁, Cₖ, Cₖ₊₁} is identified as the C-shape leakage component, C₀, C₁, Cₖ are removed from X₃, and Lₖ₊₁ is removed from [symbol] .

Step 4: In step 4, strip-like leakage components on the posterior of X₃ are removed.

For each candidate component Lₖ₊₁={C₀, C₁, Cₖ, Cₖ₊₁}ε [symbol] , if it is located at the posterior of mass center G(x, y, z) of the region Ω₃, i.e., y₀+k+1<G_{y}, then it is identified as a leakage component. C₀, C₁, Cₖ are then removed from X₃ whereas Lₖ₊₁ is removed from [symbol] .

The final X₃ region is the segmentation result of the third ventricle.

### Step 312: Fourth Ventricle and Adequate Segmentation

Since there is no well-defined boundary between the fourth ventricle and the adequate, they are segmented simultaneously. Applying hysterical thresholding on the region Ω₄, a volume X₄ is obtained. At the joint of the aqueduct and the fourth ventricle, since the posterior wall (i.e. corpora quadrigemina) of the aqueduct becomes very thin and may not be identified from the image, X₄ may “leak” from the fourth ventricle to the basal cistern surrounding the cerebellum. At the same time, since the aqueduct is only a narrow path connecting the third and fourth ventricles, a part of the aqueduct or the entire aqueduct may not be included in X₄.

Step 312a: Shape-Based Trimming of the Fourth Ventricle

To remove the “leakage”, the number of voxels f(z) in each axial slice of volume X₄ indexed as coordinate z is calculated. The slice zₘₐₓ where f(z) reaches its maximum is located. For slices with f(z)>0, the relative increase ratio from the slice zₘₐₓ to subsequent slices in the superior (or dorsal) direction is calculated according to Equation (7).

q(z)=[f(z+1)−f(z)]/f(z) (7)

The first leakage slice from zₘₐₓ towards the ventral direction (denoted as the axial slice Zₗₑₐₖ) is located at where q(z) reaches its positive maximum since f(z) increases greatly at where the “leakage” begins. If the maximum value of q(z) is not positive, this implies that X₄ did not “leak” to the basal cistern. In this case, Zₗₑₐₖ is set as the maximum z coordinate of the voxels in V₄.

Since the adequate slants anterior to join with the third ventricle, denoting yₗₑₐₖ as the most posterior of the volume X₄ on the leakage slice zₗₑₐₖ, all voxels from Zₗₑₐₖ onwards in the dorsal direction with y coordinates less than yₗₑₐₖ are taken to be “leakage” and are removed from the volume X₄.

From the slice zₘₐₓ down towards the inferior (or dorsal) direction, it is required that f(z) does not increase. Therefore, if there is a slice zₘᵢₙ such that f(zₘᵢₙ+1)>f(zₘᵢₙ), all voxels with z coordinates less than zₘᵢₙ would be trimmed from X₄.

The final X₄ region is the segmentation result of the fourth ventricle.

To find the adequate, denoting [T_{L2}, T_{H2}] as the wide threshold obtained in region Ω₄, N_{z+}(p)={(Pₓ+i, P_{y}+k, p_{z}+k)|i,j=−1,0,1, k=0,1} as the directional neighbors of a voxel p(x,y,z) and Sₒ as all voxels of volume X₄ in the slice Zₗₑₐₖ, Sₙ₊₁ is generated from Sₙ by directional region growing according to Equation (8).

$${S}_{n + 1} = {⋃}_{p ∈ {S}_{n}} \{ q \vert q ∈ {N}_{z +} ( p ) , {T}_{L 2} \leq I ( q ) \leq {T}_{H 2} \} ( n = 0 , 1 , 2 , … ) \qquad ( 8 )$$

Sₙ₊₁ is repeatedly generated from Sₙ until Sₙ₊₁ is empty or until the number of voxels in Sₙ₊₁ is greater than the number of voxels in S₀ (i.e. #(Sₙ₊₁)>#(S₀)). The adequate volume is then taken as S₁∪S₂ . . . ∪Sₙ. If the procedure of repeatedly generating Sₙ₊₁ from Sₙ stops when #(Sₙ₊₁)>#(S₀), this may be because the detected adequate reached the third ventricle. On the other hand, if the procedure of repeatedly generating Sₙ₊₁ from Sₙ stops when Sₙ₊₁ is empty, this may be because that the detected adequate failed to reach the third ventricle due to partial volume effects. In most situations, the procedure stops when #(Sₙ₊₁)>#(S₀).

### Step 204: Build and Refine Surface Models for Ventricles

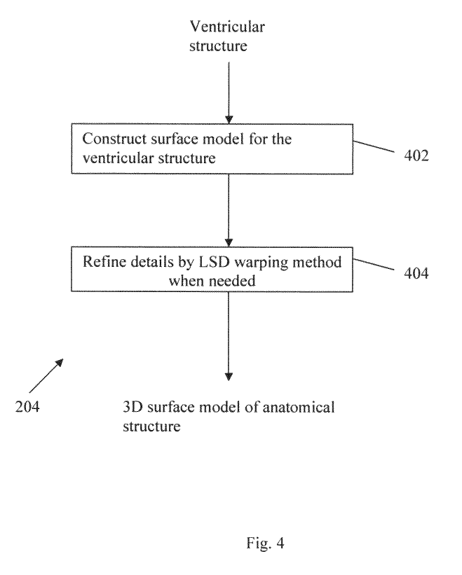

FIG. 4 illustrates a flow chart of a method 204 for generating an accurate 3D surface model of a ventricular structure from its segmentation output of method 202. In step 402, a surface model is constructed for the ventricular structure and in step 404, details of the surface model are refined by local sine warping.

Step 202 produces segmentation results of ventricles. However, some details may still be missing or inaccurate in the case where distances between slices are big and/or the studying image is of a poor quality. In such circumstances, a geometric surface model is more flexible and smoother for describing anatomical structures with subtle features lost in between image slices or disrupted by image quality. To build accurate surface models of ventricles, the well known Marching-cube method [22] can be used to generate initial surface models from the ventricle volumes output from step 202. Then the initial surface models presented as triangulated meshs are simplified [23] to reduce computing time and increase efficiency for the subsequent processing.

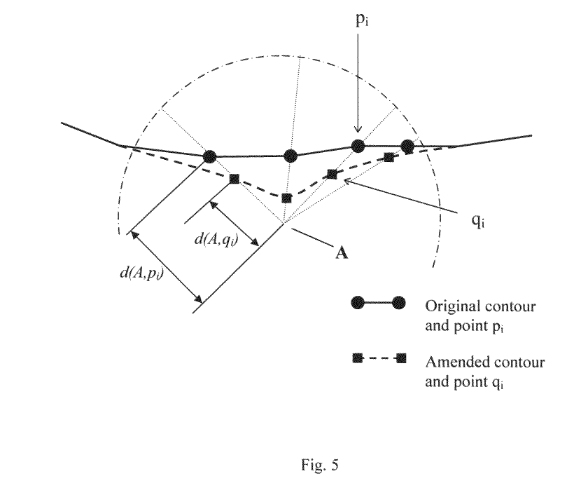

To enhance the accuracy, the system in the example embodiments supports user modification of the surface model using the local sine warping method. Based on domain knowledge, users can indicate the missing subtle features by placing amendment points on the 3D model space. The local sine deformation (LSD) function warps a confined region to smoothly approach the amendment points to recover the lost subtle features without losing the continuity of anatomy structures (as shown in FIG. 5).

FIG. 5 illustrates a process of modifying a surface model using an amendment point according to an embodiment of the present invention.

Suppose a user placed an amendment point A near the model M, indicating that a detail feature is missing in the model. The model is presented as a polygonal mesh, for each vertex V on the mesh, the distance from A to V is denoted as d(A,V). The distance between A and the model is d(A, M)=min(d(A,V)|VεM). Given a radius R>d(A,M), (R is adjustable in the system), a limited set of vertices points P={p₁, p₂, pₖ|d(A,pᵢ)<R} is constructed. For each point pᵢ in the set P, a corresponding point qᵢ is calculated as follows: qᵢ is positioned on the line along A to pᵢ {i=1, 2, . . . k} and the distance from A to qᵢ is computed by the LSD function according to Equation (9):

$$d ( A , {q}_{i} ) = Sin ( \frac{π d ( A , {p}_{i} )}{2 R} ) ( i = 1 , 2 , … k ) \qquad ( 9 )$$

By replacing each pᵢ with qᵢ {i=1, 2, . . . k} computed as above, the local region of the surface model is warped towards the amendment point A so that the missing subtle anatomy features can be recovered.

The surface model enhancement procedure in step 204 is an interactive procedure and can be carried out iteratively until the output is satisfactory.

### Experimental Results of Step 202

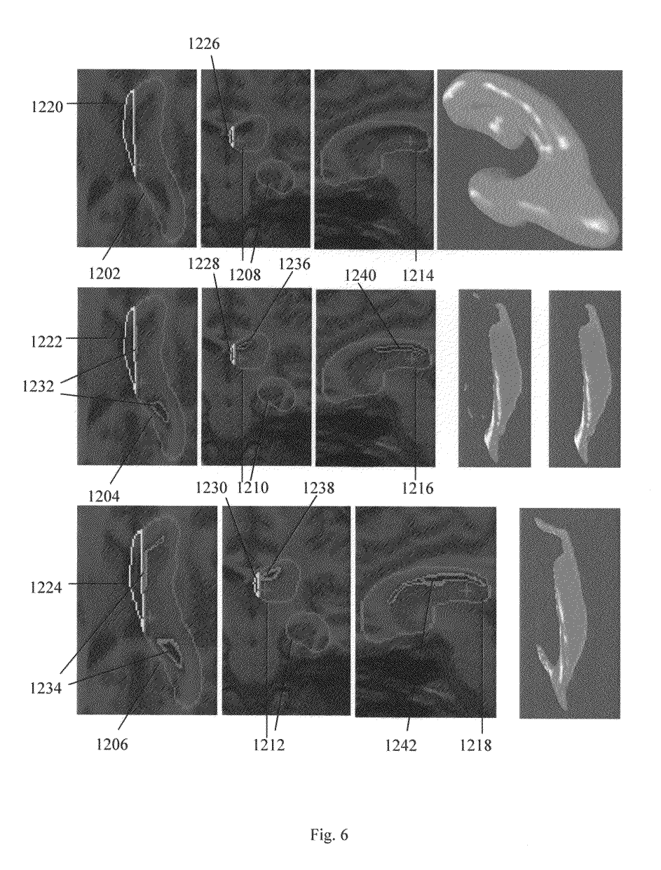

FIG. 6 illustrates the results obtained by segmenting a left ventricle in data set IBSR-18 (IBSR-18-02.1 mg, slices 144a, 57c, 120s) using method 202 and the lateral ventricle segmentation approach according to an embodiment of the present invention. Contours 1202-1218 indicate the region of interest automatically defined for the left lateral ventricle. Contours 1220-1230 indicate the region of interest of the left lateral ventricle model expanded into the middle sagittal slab. Contours 1232-1242 indicate regions obtained by the narrow thresholds and the contours surrounding contours 1231-1242 indicate the additional regions obtained by the wide thresholds.

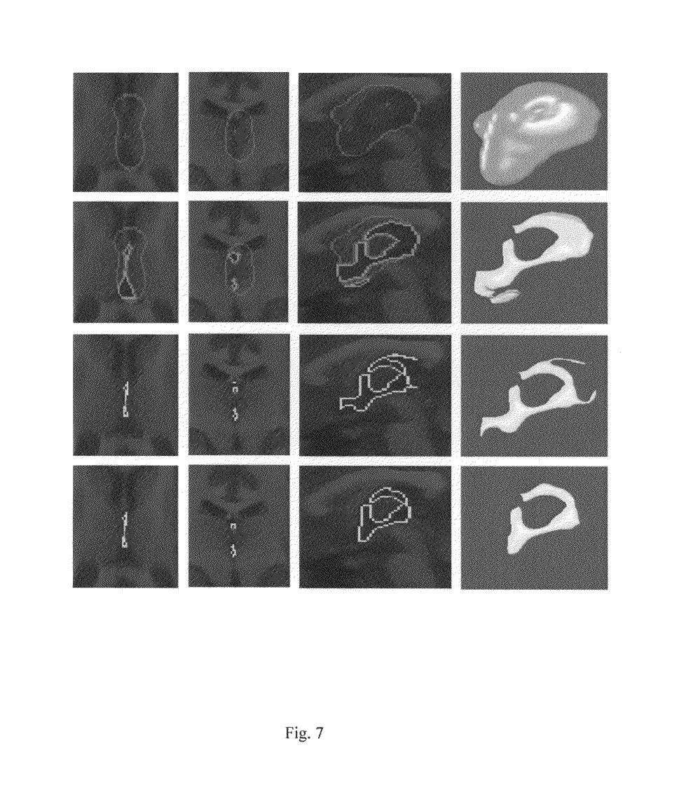

FIG. 7 illustrates the results obtained by segmenting a third ventricle in data set IBSR-18 (IBSR-18-02.1 mg, slices 142a, 60c, 128s) using method 202 according to an embodiment of the present invention. The four columns from left to right illustrate the axial, coronal, sagittal and 3D views. The first row shows the region of interest automatically defined for the third ventricle. The second row shows the results of the hysteretic thresholding in the ROI. The third row shows the results obtained by project-based trimming and the fourth row shows the final result after the landmark-guided trimming of the anterior part and shape-based trimming of other extra-ventricular components.

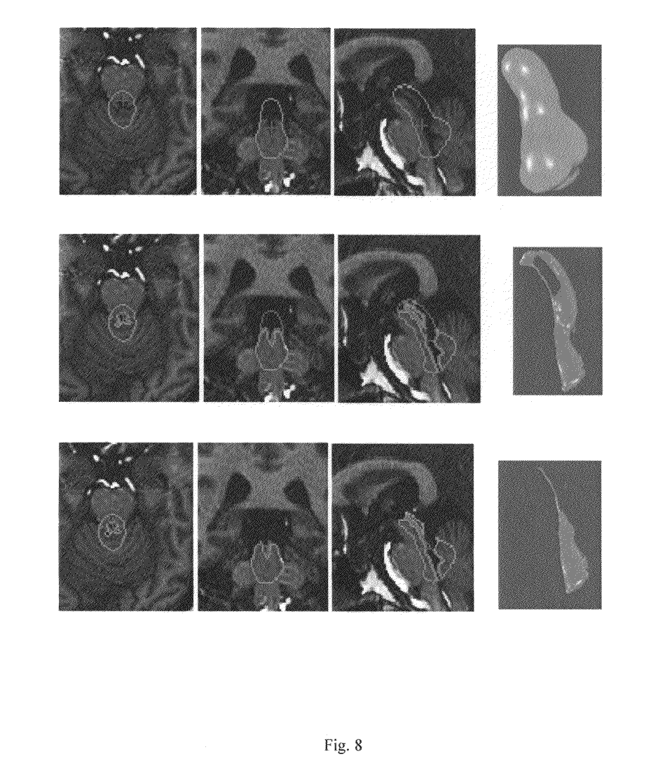

FIG. 8 illustrates the results obtained by segmenting a fourth ventricle in data set BIL-20 (BIL-Ja03, slices 44a, 102c, 129s) using method 202 according to an embodiment of the present invention. The four columns from left to right illustrate the axial, coronal, sagittal and 3D views. The first row shows the region of interest automatically defined for the fourth ventricle, the second row shows the results obtained by applying hysteretic thresholding in the ROI and the third row shows the final result after “leakage” removal.

FIG. 19 illustrates four ventricular structures segmented from four different brain volume sets in data set BIL-20 using method 202 according to an embodiment of the present invention. The first to fourth rows show the volume images of an abnormal adult's brain (with brain tumor), a normal adult's brain, a child's brain and an elder's brain. The four columns from left to right illustrate the axial, coronal, sagittal views of the original scans and the 3D views of the extracted ventricular systems respectively.

### ADVANTAGES OF EXAMPLE EMBODIMENTS

A volumetric deformable model is used in step 202 as domain knowledge to automatically define a region of interest for the segmentation of the structure to be studied, for example the ventricular structure in the example embodiments. A proper ROI is critical for an accurate segmentation. If the ROI is too small, it may not contain the structure to be studied. On the other hand, if the ROI is too large, it may contain too much unrelated information leading to wrong segmentation. In step 202, the model is first deformed to roughly fit its corresponding structure in the image by a 3D point landmark-based warping approach and the ROI is then defined by expanding (or dilating) the deformed model. The resulting ROI takes the prior shape of the structure to be studied and hence, the amount of unrelated information in the ROI is minimized. Therefore, step 202 is robust to noise and to large shape and size variations.

Furthermore, a hysteretic thresholding approach is employed for the region growing procedure in a given region of interest in step 202. In the hysteretic thresholding approach, two pairs of intensity thresholds, namely a narrow one and a wide one, are used. The range of the narrow thresholds is contained in the range of the wide thresholds. The pair of narrow thresholds is used to collect a kernel part excluding the transition regions whereas the pair of wide thresholds is used to collect the transition regions of the structure. The region growing procedure stops when “leakage” is detected. The region growing procedure in step 202 is capable of detecting transition regions while minimizing “leakage”. This is advantageous since the capability of transition region detection is critical for correct segmentation whereas “leakage” minimization greatly alleviates the burden for the region trimming procedure.

In addition, the multiple knowledge-based strategies, such as project-based, landmark guided, and shape-based trimming proposed for the region trimming procedure in step 202 are critical for the correct segmentation of the third ventricle.

Also, step 202 is advantageous over the prior art methods, for example [19]. The method proposed in [19] relies on the accurate identification of AC, PC and MSP and hence may fail to work if the supplied positions of AC, PC and MSP are not highly accurate (errors in the positions of AC and PC need to be less than 3 mm). In addition, in the method proposed in [19], only one pair of thresholds is used within a region of interest, therefore the method fails to cope with the partial volume problem which may cause disconnection of some parts of components. Particularly, the shape of the ROI used in the method in [19] is rectangular which is very different from the shape of the ventricles. Therefore, a large amount of non-ventricle tissues are included in the ROI, leading to potential segmentation errors and “leakages” in [19]. In contrast, in step 202, ten ventricular landmarks are used to warp the ventricular model to fit its corresponding ventricle structure in the image. Since the thin plate spline approximation approach [10] is used to obtain the warping function and the deformed model is further expanded to a thickness of 6 mm, step 202 is more tolerable to large landmark identification errors (up to 3.4 mm in the IBSR-18 (as shown in Table 2 in [7]). Although an erroneous identification of the anterior pole of the third ventricle can affect the accuracy of third ventricle segmentation by step 202, the effect of this is local and small since the anterior pole of the third ventricle is only used to trim the posterior of the third ventricle which is a relatively small portion of the entire third ventricle. Furthermore, the use of hysteretic thresholding in step 202, which employs two pairs of wide and narrow thresholds to develop the region of interest adaptively, ensures that transition regions are included in the ROIs while at the same time minimizing non-ventricle regions. Also, since the ROIs used in step 202 are derived from the ventricular shapes in the brain atlas, the shapes of the ROIs are very close to the shapes of the target structures, hence significantly reducing potential segmentation errors and “leakages”.

### REFERENCES

[1] J. C. Bezdek, 1981. Pattern recognition with fuzzy objective function algorithms. Plenum Press, New York.
[2] P. Besl and N. McKay, “A method for registration of 3-D shapes,” IEEE Transactions on Pattern Analysis and Machine Intelligence, 14(2), pp. 239-256, 1992.
[3] C. Baillard, P. Hellier, C. Barillot, 2000. “Segmentation of 3D brain structures using level sets and dense registration”. IEEE Workshop Math. Methods Biomed. Image Anal. 94-101.
[4] M. Holden, J. A. Schnable, D. L. G. Hill, 2001. “Quantifying small changes in brain ventricular volume using non-rigid registration”. MICCAI, 49-56
[5] K. Held, E. R. Kops, B. J. Krause, (1997). Markov random field segmentation of brain MR images. IEEE Transactions on Medical Imaging 16, 876-886.
[6] M. R. Kaus, S. K. Warfield, A. Nabavi, P.M. Black, F. A. Jolesz, R. Kikinis, 2001. “Automated segmentation of MR images of brain tumors,” Radiology 218, 586-591.
[7] J. Liu, W. Gao, S. Huang, and W. L. Nowinski, “A model-based, Semi-global Segmentation Approach for Automatic 3D Point Landmark Localization in Neuroimages”, TMI-2008 (in press)
[8] J. Liu, W. L. Nowinski, (2006), “A hybrid approach to shape-based interpolation of stereotactic atlases of the human brain,” Neuroinformatics, vol. 4, no. 2, pp. 177-198.
[9] W. L. Nowinski, G. Qian, K. N. B. Prakash, Q. Hu, A. Aziz 2006 “Fast Talairach Transformation for magnetic resonance neuroimages” July-August; 30(4):629-41. J Comput Assist Tomogr.
[10] K. Rohr, Landmark-based Image Analysis, Kluwer Academic Pub-lishers, 2001.
[11] S. M. Smith. “Fast robust automated brain extraction,” Human Brain Mapping, 17(3):143-155, November 2002.
[12] N. G. Schnack, P. H. E. Hulshoff, W. F. C. Baare, M. A. Viergever, R. S. Kahn, 2001, “Automatic segmentation of the ventricular system from MR images of the human brain”. NeuroImage 14, 95-104.
[13] M. Sonka, S. K. Tadikonda, S. M. Collins, 1996. “Knowledge-based interpretation of MR brain images”. IEEE Trans. Med. Imag. 15, 443-452.
[14] J. Talairach, P. Tournoux (1988) Co-Planar Stereotactic Atlas of the Human Brain, Stuttgart, Thieme.
[15]H. Tang, E. X., Wu, Q., Ma, Y., Gallagher, D., Perera, G. M., and Zhuang, T. (2000). “MRI brain image segmentation by multi-resolution edge detection and region selection”. Computerized Medical Imaging and Graphics 24, 349-357.

[16] W. Wells, W. Grimson, R. Kikinis, and F. Jolesz (1996) “Adaptive segmentation of MRI data”. IEEE Transactions on Medical Imaging 15, 429-442.
[17] A. J. Worth, N. Makris, M. R. Patti, J. M. Goodman, E. A. Hoge, V. S. Caviness, D. N. Kennedy, 1998. “Precise segmentation of the lateral ventricles and caudate nucleus in MR brain images using anatomically driven histograms”, IEEE Trans. Med. Imag. 17, 303-310.
[18] Y. Wang, L. H. Staib, 1998. Boundary finding with correspondence using statistical shape models. “Proceeding IEEE Conference on Computer Vision and Pattern Recognition”. IEEE Press, Washington, D.C., pp. 338-345.
[19] Y. Xia, Q. Hu, A. Aziz and W. L. Nowinski, “A knowledge-driven algorithm for a rapid and automatic extraction of the human cerebral ventricular system for MR meuroimages.”. NeuroImage, 21, 2004, pp. 269-282.
[20] C. Yan, N. Sangt, and T. Zhang, 2003, “Local entropy-based transition region extraction and thresholding”, Pattern recognition letters, 24 (2003), pp. 2935-2941
[21] Y. Zhang, M. Brady, and S. Smith (2001) “Segmentation of Brain MR Images through hidden markov random field model and the expectation maximization algorithm”. IEEE Transactions on Medical Imaging 20, 45-57.

[22] Lorensen W E and Cline H E, “Marching Cubes: A High Resolution 3D Surface Construction Algorithm,” Computer Graphics, 1987, 21(4), 163-169
[23] P. Lindstrom and G. Turk, “Fast and Memory Efficient Polygonal Simplification,” Proc. Visualization '98, IEEE Computer Soc. Press, October 1998, pp. 279-286.

1-19. (canceled)

20. A method for segmenting one or more anatomy structures in a three-dimensional medical image composed of medical data, the method comprising the steps of:
(a) registering a model, which comprises one or more respective anatomy models of each of the one or more anatomy structures, with the image, thereby forming a correspondence between locations in the model and respective locations in the medical image;
(b) according to said correspondence, forming one or more warped models of each of the one or more respective anatomy structures in the image wherein the one or more warped models are fitted to the one or more respective anatomy structures, and defining one or more respective regions of interest in the image based on the one or more warped models, the one or more regions of interest taking the expected shape of the one or more respective anatomy structures;
(c) performing region growing on the one or more regions of interest using the medical data to form respective volumes indicative of the respective anatomy structures; and
(d) segmenting the medical image using the respective volumes.

21. A method according to claim 20, wherein the step (b) further comprises the sub-step of:
defining the one or more respective regions of interest in the image by modifying the size of the one or more warped models.

22. A method according to claim 20, wherein the step (c) comprises, for each of the one or more regions of interest, the sub-steps of:
(i) calculating a respective narrow pair and a wide pair of intensity thresholds;
(ii) defining a kernel region of the region of interest according to the narrow pair of intensity thresholds; and
(iii) expanding the kernel region to include transition regions around the region of interest according to the wide pair of intensity thresholds to form said volume as a connected region.

23. A method according to claim 22 wherein the step (i) comprises the sub-steps of:
(iv) clustering voxels in the region of interest according to their intensities;
(v) calculating a pair of intensity thresholds for each cluster based on the intersection points of each cluster with neighboring clusters;
(vi) defining the pair of intensity thresholds for the cluster containing the intensity of the region of interest as the narrow pair of intensity thresholds; and
(vii) defining a lower limit and an upper limit of a combination of the pairs of intensity thresholds for the cluster containing the intensity of the region of interest and the cluster containing the intensity of the transition regions as the wide pair of intensity thresholds.

24. A method according to claim 22 wherein the step (ii) comprises the sub-steps of:
(viii) binarizing the image with the narrow pair of intensity thresholds to obtain a cluster; and
(ix) extracting a maximum connected region from the cluster according to a 6-neighbor connectivity approach to be the kernel region.

25. A method according to claim 22, wherein the step (iii) comprises the sub-steps of:
(x) determining active boundary voxels of the kernel region, wherein for each active boundary voxel, at least one nearest neighbor of the active boundary voxel lying external to the kernel region has an intensity within the wide pair of intensity thresholds;
(xi) grouping the active boundary voxels into boundary patches according to a 26-neighbor connectivity approach;
(xii) applying region growing on each boundary patch to obtain expanded boundary patches; and
(xiii) expanding the kernel region to include the expanded boundary patches to form a connected region.

26. A method according to claim 25, wherein the at least one nearest neighbor of the active boundary voxel is one of 26 nearest neighbors of the active boundary voxel and the active boundary voxels are grouped into boundary patches such that the active boundary voxels within each boundary patch are 26-neighbor connected.

27. A method according to claim 25, wherein applying region growing on each boundary patch to obtain expanded boundary patches further comprises the sub-steps of:
checking if a stop condition is met and if not, generating a first further patch from the boundary patch;
successively checking if the stop condition is met and if not, generating a new further patch from the most recently generated further patch; and
obtaining the expanded boundary patch for each boundary patch as a sum of the generated further patches.

28. A method according to claim 27, wherein each further patch comprises voxels which are nearest neighbors of the patch from which the further patch is generated and which have intensities within the wide pair of intensity thresholds.

29. A method according to claim 27, wherein the stop condition is met when the further patch to be generated is found to comprise no voxels or when the number of voxels in the further patch to be generated is found to be more than twice the number of voxels in the patch from which the further patch is to be generated.

30. A method according to claim 20, wherein the one or more anatomy structures are ventricles, the medical image composed of medical data is a brain scan image composed of brain scan data and the model is a brain model.

31. A method according to claim 20 in which one of said regions of interest corresponds to a third ventricle in a brain scan image, the method further comprising a trimming step comprising the sub-steps of:
(xiv) projecting the connected region onto a middle sagittal plane to obtain a projected image wherein each pixel in the projected image represents a number of voxels in the connected region along a project line leading to the pixel;
(xv) obtaining a threshold clustering values of the pixels in the projected image into two clusters; and
(xvi) removing voxels from the connected region corresponding to the pixels with values higher than the threshold.

32. A method according to claim 20, in which one of said regions of interest corresponds to a third ventricle in a brain scan image, the brain scan image comprising slices of a brain scan volume, the method further comprising a trimming step comprising the sub-steps of:
(xvii) locating candidate leakage components in the region of interest, wherein each candidate leakage component comprises connected regions lying on respective slices of the brain scan volume;
(xviii) repeatedly determining if a candidate leakage component is a C-shape leakage component; and
(xix) removing candidate leakage components which are determined to be C-shape leakage components;
wherein a candidate leakage component is determined to be a C-shape leakage component if
there is at least one other connected region lying on a neighboring slice of a terminal slice in the brain scan volume, the candidate leakage component not comprising said one other connected region lying on the neighboring slice;
the angle between mass centers of the connected regions comprised within the candidate leakage component for the terminal slice and the neighboring slice of the terminal slice and a mass center of said one other connected region on the neighboring slice of the terminal slice is less than 30°; and
each connected region comprised within the candidate leakage component is on the superior of remaining parts of the region of interest on each respective slice.

33. A method according to claim 32, wherein the trimming step further comprises the sub-steps of:
(xx) repeatedly determining if a candidate leakage component is a strip-like leakage component; and
(xxi) removing candidate leakage components which are determined to be strip-like leakage components;
wherein a candidate leakage component is determined to be a strip-like leakage component if
the candidate leakage component is located at the posterior of a mass center of the region of interest.

34. A method according to claim 32, wherein the step (xvii) further comprises the sub-steps of:
(xxii) grouping pixels on a first slice of the brain scan volume to form a preliminary candidate leakage component comprising a first connected region; and
(xxiii) repeatedly growing the preliminary candidate leakage component to include a connected region in a next slice until an area ratio of the connected region in the next slice to the connected region in the current slice is greater than a predetermined threshold.

35. A method according to claim 20, in which one of said regions of interest corresponds to a fourth ventricle in a brain scan image, the method further comprising a trimming step comprising the sub-steps of:
(xxiv) identifying a first slice in the image with a maximum number of pixels in the connected region;
(xxv) calculating an increase in the number of pixels in the connected region for subsequent superior axial slices from the first slice;
(xxvi) identifying a leakage slice having the greatest increase in the number of pixels in the connected region; and
(xxvii) removing voxels from the connected region lying superior the leakage slice.

36. A method according to claim 20, in which one of said regions of interest corresponds to a fourth ventricle in a brain scan image, the method further comprising a trimming step comprising the sub-steps of:
(xxviii) identifying a first slice with a greater number of pixels in the connected region as compared to a previous slice; and
(xxix) removing voxels from the connected region lying inferior the first slice.

37. A computer system having a processor arranged to perform a method according to claim 20.

38. A computer program product, readable by a computer and containing instructions operable by a processor of a computer system to cause the processor to perform a method according to claim 20.
